(19) United States
(12) Patent Application Publication
(10) Pub. No.: US 2026/0296459 A1
(43) Pub. Date: Oct. 1, 2026

(54) IN-VEHICLE ELECTRONIC CONTROL DEVICE, INSPECTION METHOD, AND NON-TRANSITORY COMPUTER READABLE STORAGE MEDIUM

(71) Applicant: DENSO CORPORATION, Kariya-city (JP)

(72) Inventor: Tomoya INOUE, Kariya-city (JP)

(21) Appl. No.: 19/560,525

(22) Filed: Mar. 9, 2026

(30) Foreign Application Priority Data
Apr. 1, 2025 (JP) 2025-060646

(51) Int. Cl. B60W 50/02; B60W 50/00; B60W 50/14

(52) U.S. Cl. CPC B60W 50/0205; B60W 50/14; B60W 2050/0095

(57) ABSTRACT

It is determined whether or not to switch from a normal operation mode in which a normal operation is executed to an inspection mode in which an inspection is executed for each of the plurality of functions based on the operation state of the in-vehicle electronic control device when the in-vehicle electronic control device is mounted on the vehicle. Therefore, it is possible to switch to the inspection mode and inspect one of the functions that does not need to function in the normal operation mode. Therefore, it is possible to execute the inspection of a plurality of functions of the electronic control device while minimizing the influence on the control of the vehicle.

### CROSS REFERENCE TO RELATED APPLICATION

The present application claims the benefit of priority from Japanese Patent Application No. 2025-060646 filed on Apr. 1, 2025. The entire disclosure of the above application is incorporated herein by reference.

### TECHNICAL FIELD

The present disclosure relates to an in-vehicle electronic control device that executes an inspection of a plurality of functions while mounted on a vehicle, an inspection method executed by the in-vehicle electronic control device, and non-transitory computer readable storage medium for the inspection method.

### BACKGROUND

For example, a conceivable technique teaches that by connecting a connector of a failure diagnosis device to an OBD2 connector, failure diagnosis information output from each electronic control unit (hereinafter referred to as ECU) provided in a system that controls a vehicle can be acquired and displayed.

### SUMMARY

According to an example, an in-vehicle electronic control device executes an inspection of each of a plurality of functions that the in-vehicle electronic control device has in a state where the in-vehicle electronic control device is mounted on a vehicle. The in-vehicle electronic control device includes at least one of (i) a circuit and (ii) a processor with a memory storing computer program code executable by the processor. The at least one of the circuit and the processor may be configured to cause the in-vehicle electronic control device to execute: acquiring information about an operation state of the in-vehicle electronic control device; determining whether or not each of the plurality of functions are able to be switched from a normal operation mode in which an normal operation is executed to an inspection mode in which the inspection is executed, based on the operation state acquired in the acquiring of the information; and switching to the inspection mode and executing the inspection for one of the plurality of functions that has been determined to be able to be switched to the inspection mode.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram conceptually showing an in-vehicle ECU according to an embodiment of mounted on a vehicle;

FIG. 2 is a block diagram showing an example of the configuration of an in-vehicle ECU;

FIG. 3 is a flowchart showing an example of a process for inspecting a plurality of functions of an in-vehicle ECU;

FIG. 4 is an explanatory diagram for explaining how the operation state of the in-vehicle ECU in a vehicle is determined based on whether a user is disposed in the compartment of the vehicle, whether the battery of the vehicle is being charged, whether the driver is driving the vehicle, and the shift position of the transmission of the vehicle;

FIG. 5 is a diagram showing a configuration for inspecting a power supply function using a power supply circuit in an in-vehicle ECU;

FIG. 6 is a diagram showing PCI communication between a first SoC and a second SoC of an in-vehicle ECU;

FIG. 7A is a diagram showing an example of how a communication signal changes in a normal state, and FIG. 7B is a diagram showing an example of how a communication signal changes in a deterioration state;

FIG. 8A is a diagram showing an example of how a communication signal changes under a normal condition when the communication speed is increased compared to the example shown in FIG. 7A, and FIG. 8B is a diagram showing an example of how a communication signal changes under the deterioration state when the communication speed is increased compared to the example shown in FIG. 7A;

FIG. 9 is a diagram illustrating an example of the configuration of a gyro sensor;

FIG. 10 is a diagram showing an example of hardware flags associated with a plurality of functions in an in-vehicle ECU according to a second embodiment;

FIG. 11 is a diagram showing an example of a condition for permitting a switch to an inspection mode of one function of an in-vehicle ECU;

FIG. 12 is a diagram showing that the state shown in FIG. 10 is changed to a state in which the PCI hardware flag has been turned off; and

FIG. 13 is a diagram showing that the condition for permitting a switch to the inspection mode is satisfied in response to the PCI hardware flag of FIG. 12 being turned off.

### DETAILED DESCRIPTION

Generally, the information for the failure diagnosis output from each ECU is a failure code corresponding to the anomaly item detected by the ECU through the self-diagnosis function of each ECU. Here, the number of anomaly items that can be specified by the failure code is limited.

Therefore, there is a need for technique that can more broadly inspect the various functions of each ECU. Here, the various functions of each ECU are generally used for various controls in the vehicle. Therefore, when inspecting the various functions of each ECU, it is necessary to take care to minimize the influence on the vehicle control that utilizes those functions.

The present embodiments have been made in consideration of the above-mentioned points, and aims to provide an in-vehicle electronic control device that can execute an inspection of multiple functions while minimizing the influence on control in the vehicle, and an inspection method executed by the in-vehicle electronic control device.

In order to achieve the above object, an in-vehicle electronic control device according to the present embodiments is an in-vehicle electronic control device that executes an inspection of a plurality of functions that the in-vehicle electronic control device has when mounted on a vehicle.

The in-vehicle electronic control device includes: an acquisition unit that acquires information about an operating state of the in-vehicle electronic control unit; a determination unit that determines whether or not each of the plurality of functions are able to be shifted from a normal operation mode in which an normal operation is executed to an inspection mode in which the inspection is executed, based on the operation state acquired by the acquisition unit; and an inspection unit that switches to the inspection mode and executes the inspection for one of the plurality of functions that have been determined by the determination unit to be able to be switched to the inspection mode.

In addition, the inspection method according to the present embodiments is an inspection method for inspecting a plurality of functions of an in-vehicle electronic control device using the in-vehicle electronic control device when the in-vehicle electronic control device is mounted on a vehicle. The inspection method includes: acquiring information about an operating state of the in-vehicle electronic control unit; determining whether or not each of the plurality of functions are able to be shifted from a normal operation mode in which an normal operation is executed to an inspection mode in which the inspection is executed, based on the operation state; and switching to the inspection mode and executes the inspection for one of the plurality of functions that have been determined that is able to be switched to the inspection mode.

Thus, according to the in-vehicle electronic control device and the inspection method in the present embodiments, whether or not to switch from a normal operation mode in which a normal operation is executed to an inspection mode in which an inspection is executed is determined for each of a plurality of functions based on the operation state of the in-vehicle electronic control device when the in-vehicle electronic control device is mounted in a vehicle. Therefore, it is possible to switch to the inspection mode and inspect one of the functions that does not need to function in the normal operation mode. Therefore, it is possible to execute the inspection of a plurality of functions of the electronic control device while minimizing the influence on the control of the vehicle.

The reference signs and/or numerals in parentheses are merely added to indicate examples of correspondence relationships with concrete structures in the below-described embodiments in order to facilitate the understanding of the present disclosure, which has no intention to limit the scope of the present disclosure in any manner.

Technical features described in the following sections other than the above-mentioned features become apparent from the description of the embodiments and the accompanying drawings.

Hereinafter, embodiments of an in-vehicle electronic control device and an inspection method according to the present embodiments will be described with reference to the drawings. The present disclosure is not limited to the following embodiments, and various modified examples described below are also included in the technical scope of the present disclosure. In addition to the following embodiments, various modifications can be made without departing from the spirit and scope of the present embodiments. The embodiments and various modifications can be combined to extent that does not cause technical inconsistency. In the following description, the same or similar components may be denoted by the same or similar reference symbols throughout the drawings, and descriptions thereof may be omitted. In addition, in a case where only a part of the configuration is referred to in an embodiment or modification example, the description in the foregoing embodiment may be applied to the remaining configuration.

### First Embodiment

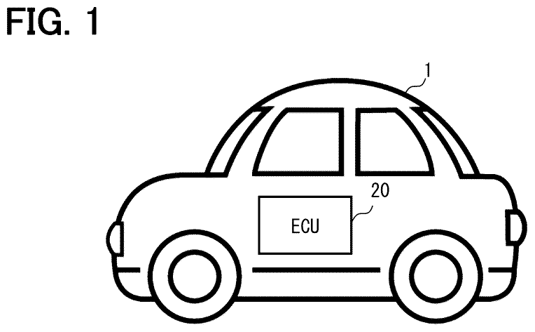

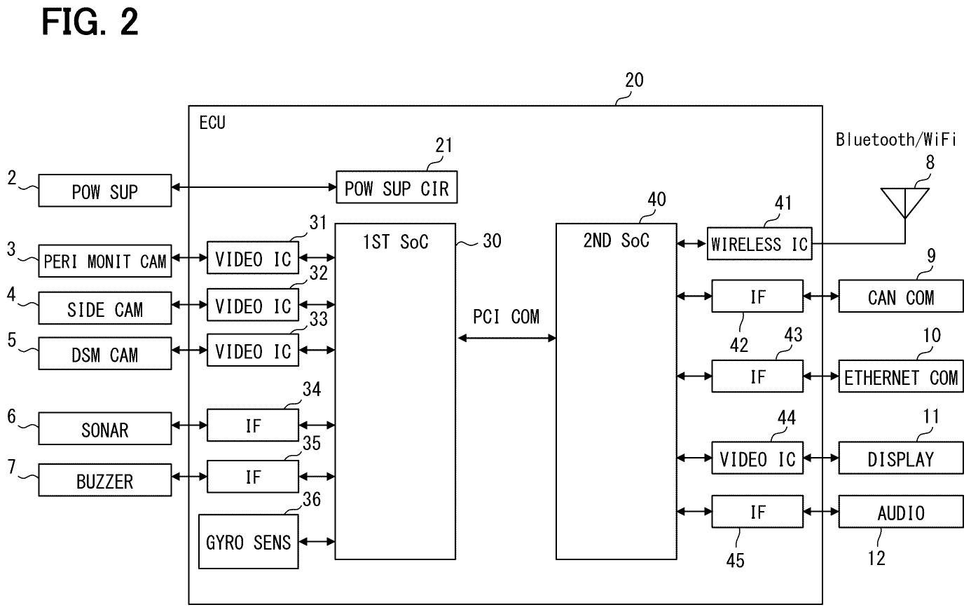

FIG. 1 is a diagram conceptually showing a state in which an in-vehicle electronic control device (hereinafter referred to as in-vehicle ECU) 20 according to this embodiment is mounted on a vehicle 1. Although FIG. 1 illustrates an automobile as the vehicle 1, the in-vehicle ECU 20 according to the embodiment is not limited to being applied to automobiles. For example, the in-vehicle ECU 20 according to the embodiment may be applied to various vehicles such as motorcycles, transportation vehicles, construction vehicles, agricultural vehicles, and railway vehicles.
FIG. 2 is a block diagram showing an example of a configuration of an in-vehicle ECU 20. As shown in FIG. 1, the in-vehicle ECU 20 may include, for example, a plurality of systems on chips (hereinafter referred to as SoCs). FIG. 2 shows an example in which the in-vehicle ECU 20 has two SoCs, a first SoC 30 and a second SoC 40. Here, the in-vehicle ECU 20 may have only one SoC, or may have three or more SoCs.

The first SoC 30 and the second SoC 40 are each a single semiconductor chip that integrates multiple electronic circuits, such as a processor such as a CPU (Central Processing Unit) or a GPU (Graphics Processing Unit), a memory such as a DRAM (Dynamic Random Access Memory), a storage such as an eMMC (Embedded Multi Media Card) or an SSD (Solid State Drive), and a communication module. The first SoC 30 and the second SoC 40 can be configured to be able to communicate with each other via PCI (Peripheral Component Interconnect) communication such as PCI-Express, for example.

Here, FIG. 1 shows an example in which the video ICs 31, 32, 33, and 44, the wireless IC 41, and the peripheral device interfaces (IFs) 34, 35, 42, 43, and 45 are provided outside the first SoC 30 and the second SoC 40. However, the video ICs 31, 32, 33, and 44, the wireless IC 41, and the IFs 34, 35, 42, 43, and 45 of the peripheral devices may also be integrated into the first SoC 30 or the second SoC 40.

The in-vehicle ECU 20 includes a power supply circuit 21 for supplying drive voltages to the first SoC 30, the second SoC 40, and the like. The power supply circuit 21 includes a power supply IC that converts a power supply voltage supplied from a power supply 2, which is a battery mounted on the vehicle 1, into a drive voltage for the supply destination and outputs the converted voltage. For example, a plurality of power supply ICs may be provided in the power supply circuit 21 in correspondence with the respective components integrated in the first SoC 30 and the second SoC 40.

The first SoC 30 is connected to the periphery monitoring camera 3 via a video IC 31. The periphery monitoring camera 3 is provided, for example, inside or outside the compartment of the vehicle 1 and captures images of the area in front of and/or behind the vehicle 1. The periphery monitoring camera 3 repeatedly outputs captured video data to the first SoC 30. The first SoC 30 is also connected to the side camera 4 via the video IC 32. The side camera 4 is, for example, built into a door mirror of the vehicle 1 and captures images of the side area of the vehicle 1. The side camera 4 repeatedly outputs captured video data to the first SoC 30. Furthermore, the first SoC 30 is connected to a driver status monitor (hereinafter referred to as DSM) camera 5 via a video IC 33. The DSM camera 5 is attached, for example, to a dashboard in front of the driver's seat of the vehicle 1 and captures an image of the driver's face. The DSM camera 5 repeatedly outputs captured video data to the first SoC 30.

The first SoC 30 can generate a bird's-eye view image of the periphery of the vehicle 1 from above the vehicle, for example, based on the video data output from the periphery monitoring camera 3 and the video data output from the side camera 4. The generated bird's-eye view image can be transmitted, for example, from the first SoC 30 to the second SoC 40 and displayed on the display 11 via the image IC 44.

In addition, the first SoC 30 can acquire information about an obstacle disposed around the vehicle 1 by executing an image recognition process on the video data output from the periphery monitoring camera 3. The acquired information about the obstacle can be transmitted to a safety control ECU (not shown) via the second SoC 40 and the IFs 42 and 43 using the CAN communication 9 or the Ethernet communication 10. CAN and ETHERNET are registered trademarks. In the following description, the terms of the registered trademarks of CAN and ETHERNET will be omitted. Based on the received information about the obstacle, the safety control ECU can execute control such as warning the driver, braking the vehicle 1, and/or steering the vehicle 1 to avoid the obstacle.

Furthermore, the first SoC 30 can execute the image analysis based on the video data output from the DSM camera 5 to detect whether the driver is looking away or falling asleep while driving. Based on the detection results, the first SoC 30 can sound a buzzer 7 to warn using a drive signal transmitted via the IF 35, display a message on the display 11 using the image data transmitted via the second SoC 40 and the video IC 44, and/or issue an audio warning from the audio circuit 12 using the audio data transmitted via the second SoC 40 and the IF 45.

The periphery monitoring camera 3, the side camera 4, and the DSM camera 5 each include a serializer that converts the video data, which is a parallel signal, into a serial signal. This feature can reduce the number of signal lines between the periphery monitoring camera 3, the side camera 4, and the DSM camera 5 and the in-vehicle ECU 20. The video ICs 31, 32, and 33 connected to the periphery monitoring camera 3, the side camera 4, and the DSM camera 5, respectively, are equipped with deserializers that convert the video data transmitted as serial signals back into parallel signals. The video ICs 31, 32, and 33 output the video signals converted back into parallel signals to the first SoC 30. Differential communication is executed between the periphery monitoring camera 3, the side camera 4, and the DSM camera 5 and the respective image ICs 31, 32, and 33 in accordance with, for example, the MIPI (Mobile Industry Processor Interface) standard.

The first SoC 30 is connected to the sonar 6 via the IF 34. The sonars 6 are arranged, for example, at the four corners of the vehicle 1, and transmit ultrasonic waves and receive ultrasonic waves reflected by nearby reflection objects. For example, when the vehicle 1 is reversing or traveling at a low speed, the first SoC 30 instructs the sonar 6 to detect reflection objects via the IF 34. In response to this detection instruction, the sonar 6 starts emitting ultrasonic waves. When a reflection object is disposed around the vehicle 1 and the reflected ultrasonic waves are received, the area in which the reflection object exists and the distance to the reflection object are transmitted to the first SoC 30 via the IF 34.

The first SoC 30 is connected to the buzzer 7 via the IF 35. As described above, the buzzer 7 can output a warning sound in response to receiving a drive signal from the first SoC 30 via the IF 35.

The first SoC 30 is connected to a gyro sensor 36. The gyro sensor 36 detects the rotational angular velocity of the vehicle 1. The gyro sensor 36 incorporates a BIST (Built in Self Test) circuit therein. The rotational angular velocity detected by the gyro sensor 36 is input to the first SoC 30. The first SoC 30 transmits, for example, the rotational angular velocity of the vehicle 1 to a safety control ECU or a car navigation ECU via the CAN communication 9 or the Ethernet communication 10. The safety control ECU can detect, based on the rotational angular velocity of the vehicle 1, that the behavior of the vehicle 1 has become unstable due to sudden steering, skidding, or the like. In this case, the safety control ECU can control the braking force and driving force so that the behavior of the vehicle 1 is stabilized. Furthermore, the car navigation ECU can use the rotational angular velocity of the vehicle 1 to calculate the vehicle's position using autonomous navigation.

The second SoC 40 is connected to the antenna 8 via a wireless IC 41. The wireless IC 41 can execute the wireless communication with a mobile terminal carried by an occupant of the vehicle 1, including the driver, via Bluetooth or Wi-Fi, for example. Bluetooth and Wi-Fi are registered trademarks. In the following description, the terms of the registered trademarks of Bluetooth and Wi-Fi will be omitted.

The second SoC 40 is capable of execute the CAN communication 9 with other ECUs via the IF 42. That is, the IF 42 is a CAN transceiver, and can communicate with a CAN transceiver provided in another ECU according to the CAN communication protocol. The second SoC 40 can also execute the ETHERNET communication 10 with other ECUs via the IF 43. That is, the IF 43 is an ETHERNET transceiver, and can communicate with an ETHERNET transceiver provided in another ECU according to the ETHERNET communication protocol.

The second SoC 40 is connected to the display 11 via a video IC 44. The second SoC 40 can display any video on the display 11 by outputting the video data via the video IC 44. In this case, the video IC 44 has a serializer, and the display 11 has a deserializer.

The second SoC 40 is connected to the audio circuit 12 via the IF 45. The audio circuit includes a speaker. The second SoC 40 outputs audio data via the IF 45, thereby enabling the audio circuit 12 to output any audio.

As described above, the in-vehicle ECU 20 has a variety of functions, such as a power supply function, a video data reception function, a reflection object data reception function, a warning sound generation function, a rotational acceleration data detection function, a communication function, a video display function, and an audio output function. These functions may deteriorate as the in-vehicle ECU 20 is used. Therefore, there is a need for technique that can inspect the various functions of the in-vehicle ECU 20 when the ECU 20 is mounted on the vehicle to detect anomalies such as failures that interfere with normal operation, or signs of failure that are likely to cause a failure even if the in-vehicle ECU 20 has not yet been failed.

However, the various functions of the in-vehicle ECU 20 are usually used for various controls in the vehicle 1. If each function is to be inspected, there is a high possibility that the function being inspected will not be available for the control in the vehicle 1. Therefore, when inspecting the various functions of the in-vehicle ECU 20, it is necessary to take care to minimize the influence on the control of the vehicle 1 that utilizes those functions.

Therefore, the in-vehicle ECU 20 according to this embodiment determines whether or not it is possible to switch from a normal operation mode in which the normal operation is executed to an inspection mode in which the inspection is executed for each of a plurality of functions, based on the operation state of the in-vehicle ECU 20 mounted in the vehicle 1. This allows functions that do not need to operate in the normal operation mode to be switched to the inspection mode and inspected. Therefore, it is possible to execute the inspection of the multiple functions of the in-vehicle ECU 20 without affecting the control of the vehicle 1 as much as possible.

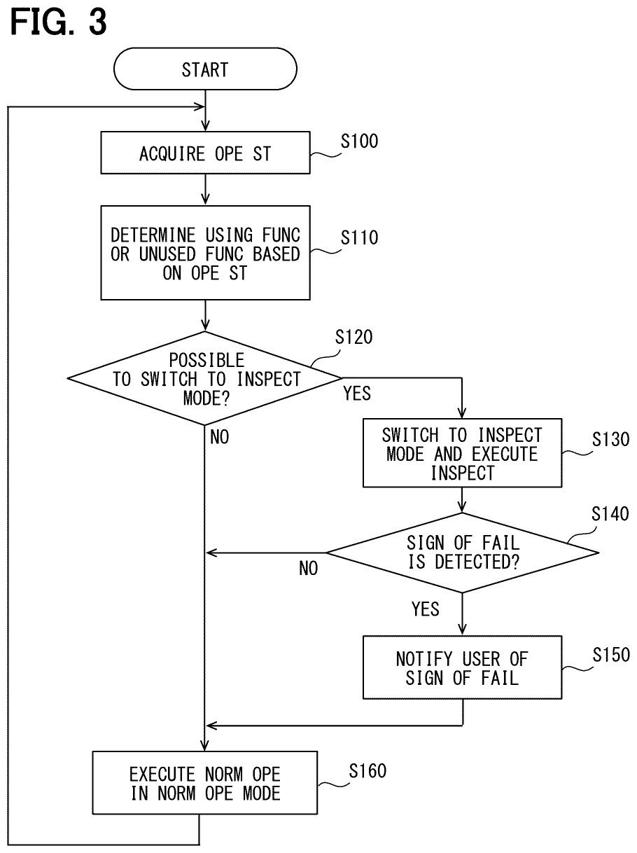

An example of a process for inspecting a plurality of functions of the in-vehicle ECU 20 will be described below with reference to the flowchart of FIG. 3. The execution of the process shown in the flowchart of FIG. 3 by the in-vehicle ECU 20 corresponds to the execution of the inspection method of the present embodiments.

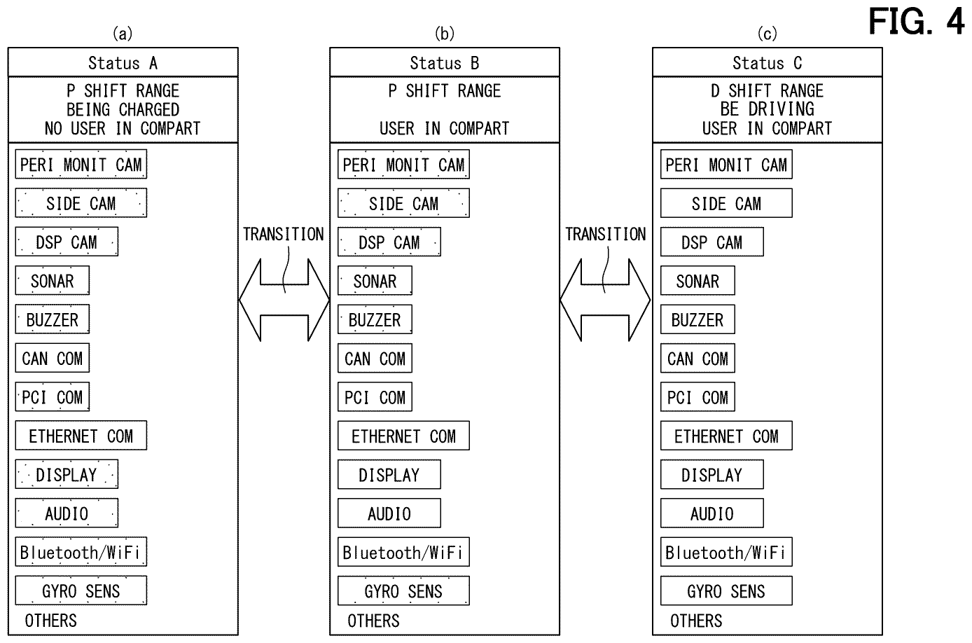

In step S100, the in-vehicle ECU 20 acquires information relating to the operation state of the in-vehicle ECU 20 mounted on the vehicle 1. The process of S100 corresponds to the acquisition unit of the present embodiments. the information relating to the operation state of the in-vehicle ECU 20 mounted in the vehicle 1 may include, as shown in (a) to (c) in FIG. 4, whether a user is disposed in the compartment of the vehicle, whether charging is in progress, whether the driver is driving the vehicle 1, and the shift position of the transmission. Note that whether or not the vehicle 1 is being charged can be taken into consideration when the vehicle 1 is equipped with an electric motor as a drive source and a high-voltage battery that supplies power to the electric motor, and the high-voltage battery is externally chargeable.

In step S110, the in-vehicle ECU 20 determines which of its own functions will be used and which will not be used among the plurality of functions, based on the information on the operation state acquired in step S100.

For example, in status A shown in (a) of FIG. 4, the user is not disposed in the compartment of the vehicle 1, the vehicle 1 is being charged, and the shift position is in a parking position, i.e., P position. Since no user is disposed in the compartment of the vehicle 1, the multimedia-related functions such as the video display function using the display 11 and the audio output function using the audio circuit 12 do not need to operate and can be determined to be unused functions. Furthermore, since there is no need for communication between the first SoC 30 and the second SoC 40, the PCI communication function between the first SoC 30 and the second SoC 40 can also be determined to be an unused function.

Furthermore, in status A shown in (a) of FIG. 4, the vehicle 1 is stopped and no user is disposed in the compartment of the vehicle, so it is considered that the various cameras 3, 4, 5, the sonar 6, the buzzer 7, and the gyro sensor 36 do not need to operate to assist the driver in safe driving. Therefore, it can be determined that the functions of receiving the video data using the various cameras 3, 4, and 5, receiving the reflection object data using the sonar 6, generating the warning sound using the buzzer 7, and receiving the data from gyro sensor 36 are not unused functions. In addition, since the user is not disposed in the compartment of the vehicle, it is considered that there is no need to communicate with the mobile terminal carried by the user. Therefore, the communication function using the wireless IC 41 and the antenna 8 can be determined as an unused function.

On the other hand, while the vehicle is parked, for example, the verification ECU may periodically transmit a request signal to the portable key carried by the driver and attempt to communicate with the portable key. When a response signal is returned from the portable key and the response signal includes an identifier corresponding to the identifier of the proper portable key, the verification ECU can detect that a driver carrying the proper portable key is disposed in the periphery of the vehicle. In response to this detection, or in response to the driver attempting to open the door, the verification ECU communicates with other ECUs, including the in-vehicle ECU 20, via the CAN communication 9 or the Ethernet communication 10 to unlock the door and prepare for the user to get in. Therefore, in the status A shown in (a) of FIG. 4, the communication functions of the in-vehicle ECU 20 using the CAN communication and the ETHERNET communication are determined to be functions that will be used.

Here, as described above, it is highly likely that the CAN communication 9 and/or the ETHERNET communication 10 will not be used until the user gets in the vehicle. Therefore, for example, when the in-vehicle ECU 20 confirms that there is a low possibility that the CAN communication 9 and/or the ETHERNET communication 10 are used between the in-vehicle ECU 20 and the other ECU which is a communication target of the CAN communication 9 and/or the ETHERNET communication 10, it may determine that the communication functions using the CAN communication and the ETHERNET communication are functions that will not be used.

In (a) of FIG. 4, peripheral devices and the like related to unused functions of the in-vehicle ECU 20 are shaded with dotted lines. Conversely, the peripheral devices and the like related to the functions used by the in-vehicle ECU 20 are not shaded. This also applies to (b) and (c) of FIG. 4.

In status B shown in (b) of FIG. 4, the user is disposed in the compartment of the vehicle 1 and the shift position is in the parking position, i.e., the P position. Since the user is disposed in the compartment of the vehicle 1, the video display function using the display 11 and the audio output function using the audio circuit 12, which are multimedia-related functions, are determined to be functions that will be used. Additionally, the PCI communication function between the first SoC 30 and the second SoC 40 is also determined to be a function to be used. Furthermore, in order to enable communication with a portable terminal carried by the user, a communication function using the wireless IC 41 and the antenna 8 is also determined as a function to be used.

On the other hand, in status B shown in (b) of FIG. 4, the shift position is in the parking position and the vehicle 1 is stopped. Therefore, it is considered that the various cameras 3, 4, 5, the sonar 6, the buzzer 7, and the gyro sensor 36, which are intended to assist the driver in safe driving, do not need to operate. Therefore, it can be determined that the functions of receiving the video data using the various cameras 3, 4, and 5, receiving the reflection object data using the sonar 6, generating the warning sound using the buzzer 7, and receiving the data from gyro sensor 36 are not unused functions.

In status C shown in (c) of FIG. 4, the user is disposed in the compartment of the vehicle 1, the shift position is in a drive position, i. e,, a D position, and the user is driving the vehicle 1. Therefore, all functions of the in-vehicle ECU 20 are determined to be functions that will be used.

In step S120 of the flowchart in FIG. 3, the in-vehicle ECU 20 determines, based on the determination result in step S110, whether or not to switch from a normal operation mode in which the normal operation is executed to an inspection mode in which the inspection is executed for each of the multiple functions possessed by the in-vehicle ECU 20. The processes of steps S110 and S120 correspond to the determination unit of the present embodiments. More specifically, the in-vehicle ECU 20 determines in step S110 that the function determined to be an unused function can be shifted to the inspection mode. Conversely, the in-vehicle ECU 20 determines in step S110 that the function determined to be used is not to be switched to the inspection mode. This makes it possible to inspect a plurality of functions without affecting, as much as possible, the control of the vehicle that uses each of the functions.

If it is determined in step S120 that there is a function that can be switched to the inspection mode, the in-vehicle ECU 20 proceeds to step S130. On the other hand, if there is no function for which it has been determined that the switch to the inspection mode is possible, the in-vehicle ECU 20 proceeds to the process of step S160.

In step S130, the in-vehicle ECU 20 switches to the inspection mode and executes an inspection on the functions that have been determined to be able to be switched to the inspection mode. The process of step S130 corresponds to the inspection unit of the present embodiments. Below we will explain some of the inspections and how they are executed.

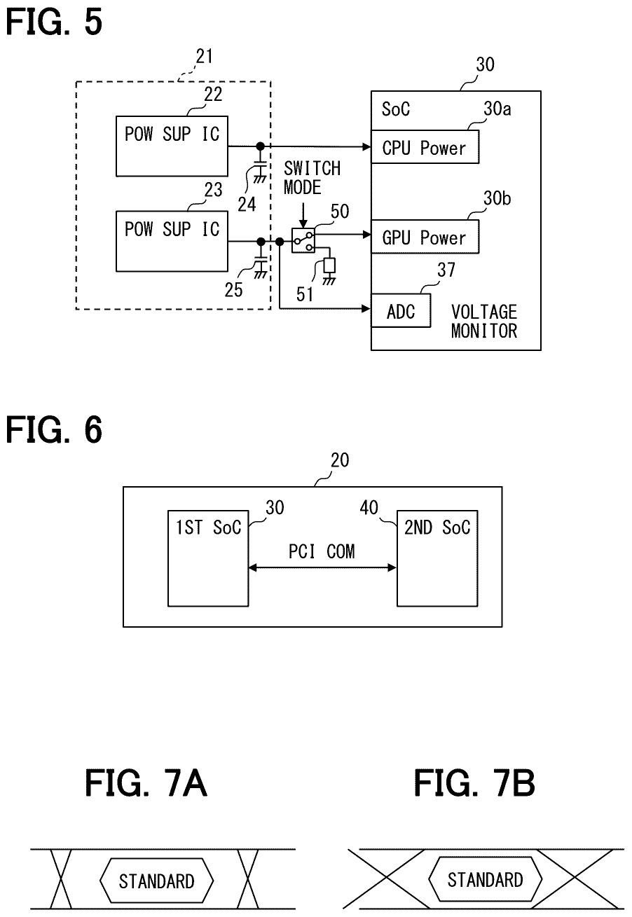

FIG. 5 is a diagram showing a configuration for inspecting the power supply function using the power supply circuit 21 in the in-vehicle ECU 20. In the example shown in FIG. 5, the power supply circuit 21 includes a power supply IC 22 for supplying a drive voltage 30a to the CPU, and a power supply IC 23 for supplying a drive voltage 30b to the GPU. The power supply circuit 21 also includes a capacitor 24 for smoothing the output voltage of the power supply IC 22 and a capacitor 25 for smoothing the output voltage of the power supply IC 23. The number of power supply ICs 22 and 23 included in the power supply circuit 21 may be three or more, instead of two.

The capacitors 24 and 25 may deteriorate due to use of the in-vehicle ECU 20. Here, even if the capacitor 25 deteriorates due to the use of the in-vehicle ECU 20, if the GPU of the first SoC 30 operates under a normal load and a normal amount of current flows from the power supply IC 23 to the first SoC 30, the power supply IC 23 may be able to supply a drive voltage within the normal range. However, if the capacitor 25 is deteriorated, when the in-vehicle ECU 20 operates under high load and a relatively large current flows from the power supply IC 23 to the GPU of the first SoC 30, the power supply IC 23 may not be able to supply a drive voltage within the normal range.

Therefore, the in-vehicle ECU 20 according to the embodiment has a load 51 through which a current larger than the normal current flows when a drive voltage supplied from the power supply IC 23 and the capacitor 25 is applied and an A/D converter 37 for monitoring the voltage applied to the load 51, as an inspection circuit for inspecting the power supply function using the power supply circuit 21. In this case, the power supply IC 23 and the capacitor 25 correspond to the functional circuit of the present embodiments. Furthermore, the in-vehicle ECU 20 includes a switching circuit 50 that switches the connection destination of the power supply IC 23, which serves as a functional circuit for realizing a power supply function using the power supply circuit 21, to a load 51. The switching circuit 50 can be configured, for example, by an FPGA (Field Programmable Gate Array). By using an FPGA, dynamic circuit switching becomes possible regardless of the circuit configuration.

In the in-vehicle ECU 20, for example, if the first SoC 30 determines that the power supply function to the GPU is a function not to be used, it determines that it is possible to switch from the normal operation mode to the inspection mode, and instructs the switching circuit 50 to switch the connection destination of the switching circuit 50 to the load 51. In this case, a current larger than that flowing when the GPU operates under a normal load flows from the power supply IC 23 to the load 51. Therefore, if the capacitor 25 is deteriorated, the power supply IC 23 may not be able to supply a drive voltage within the normal range.

The voltage applied to the load 51, that is, the drive voltage supplied from the power supply IC 23, is monitored by the A/D converter 37. If the monitored voltage by the A/D converter 37 drops below the normal range of the drive voltage, the first SoC 30 can determine that the power supply function to the GPU has failed or is showing a sign of failure due to deterioration of the capacitor 25.

In this way, by operating the function as the inspection target in the inspection mode at a load higher than that during the normal operation, it becomes possible to inspect for a sign of failure that may not be detected during the normal operation.

Next, the inspection of the PCI communication function between the first SoC 30 and the second SoC 40 in the in-vehicle ECU 20 will be described. As shown in FIG. 6, in the normal operation mode, the first SoC 30 and the second SoC 40 execute the PCI communication to transmit and receive various data.

As the in-vehicle ECU 20 is used for a long period of time, it is conceivable that a deviation in impedance may occur due to, for example, a change in the contact resistance of the connector of the PCI communication line between the first SoC 30 and the second SoC 40. In this case, the change in the communication signal may become dull, so that the communication performance may be deteriorated.

FIG. 7A is a diagram showing an example of how a communication signal changes in a normal state, and FIG. 7B is a diagram showing an example of how a communication signal changes in a deterioration state. As shown in FIGS. 7A and 7B, when the communication signal is deteriorated, the change in the communication signal is slower than when the communication signal is normal, and as a result, the opening of the so-called eye pattern is smaller.

Here, if the communication speed is not so high, even if the communication performance is deteriorated, the communication signal may still satisfy the standard value for the voltage difference, and the like, as shown in FIG. 7B. Therefore, the frequency of occurrence of communication errors may be low, or even if a communication error does occur, it may be possible to correct the error through a correction process, so that the normal communication operation may not be affected.

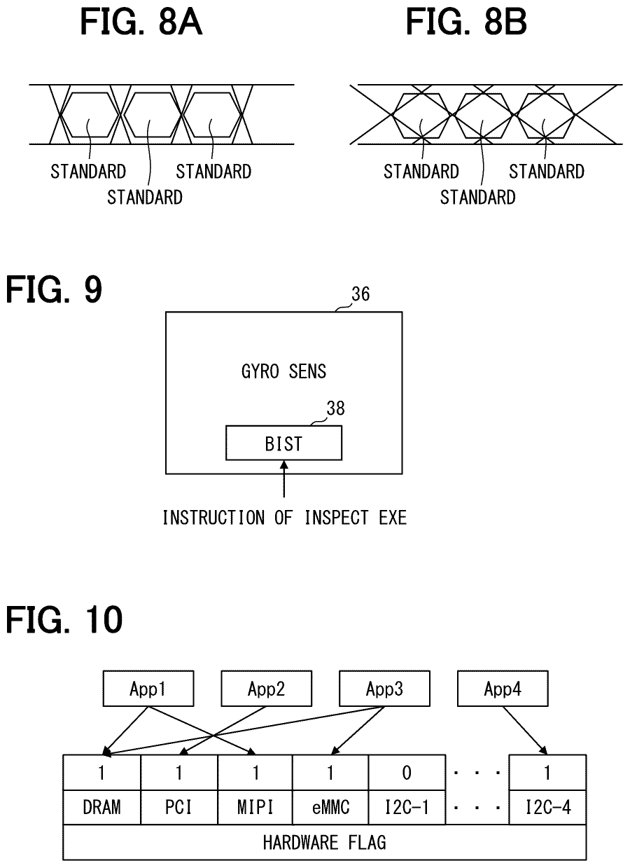

In this embodiment, in the inspection mode, the communication is executed at a communication speed higher than the communication speed in the normal operation mode. For example, the first SoC 30 and the second SoC 40 communicate at the upper limit of the communication speed for PCI communication. In this case, as shown in FIG. 8A, if the communication performance is normal, the communication signal satisfies the standard value, and the communication can be executed. On the other hand, when the communication performance is deteriorated, as shown in FIG. 8B, the change in the communication signal becomes dull, so that the communication signal no longer satisfies the standard value, and the frequency of communication errors increases.

In this way, the vehicle ECU 20 according to this embodiment can also inspect a sign of failure (i.e., deterioration of the communication function) in the PCI communication function between the first SoC 30 and the second SoC 40, to the extent that it does not interfere with the normal communication operation.

An example of a specific procedure for inspecting the PCI communication function is shown below. First, the determination as to whether or not to switch the PCI communication function to the inspection mode can be made by either the first SoC 30 or the second SoC 40. When one of the first SoC 30 and the second SoC 40 determines that the PCI communication function can be switched to the inspection mode, it notifies the other of the first SoC 30 and the second SoC 40 of the switch to the inspection mode. This notification triggers the first SoC 30 and the second SoC 40 to switch to the inspection mode and execute the inspection. Specifically, the inspection data is transmitted and received between the first SoC 30 and the second SoC 40 at the upper limit communication speed of the PCI communication. The SoC that receives the inspection data can determine whether the communication was normally executed or not, for example, by determining whether the error occurrence frequency is equal to or greater than a predetermined value.

In this way, when inspecting the PCI communication function, by operating the PCI communication function as the inspection target at a communication load higher than the communication load during the normal communication operation, it becomes possible to inspect for a sign of failure that may not be detected during the normal communication operation. Here, the inspection of the PCI communication function may not be limited to being executed under a communication load higher than that during the normal communication operation. That is, the PCI communication function may be inspected with a communication load equivalent to that during the normal communication operation.

Next, the inspection of the data detection function using the gyro sensor 36 in the in-vehicle ECU 20 will be described. As shown in FIG. 9, the gyro sensor 36 incorporates a BIST 38, which is an inspection circuit that inspects whether the gyro sensor 36 can normally detect angular velocity data. In this case, the gyro sensor 36 corresponds to the functional circuit of the present embodiments.

For example, the BIST 38 can be configured to input an inspection signal to an inspection input terminal, thereby operating the gyro sensor 36 in a pseudo manner as if an angular velocity were applied to the gyro sensor 36. The BIST 38 can then determine, from the detection signal output from the gyro sensor 36, whether or not the sensor unit and detection circuit of the gyro sensor 36 have operated in response to the inspection signal.

During the inspection by the BIST 38, the gyro sensor 36 cannot detect the angular velocity of the vehicle 1. Therefore, in the in-vehicle ECU 20 according to the embodiment, for example, when the first SoC 30 determines that the data reception function using the gyro sensor 36 is not in use and determines that the switch to the inspection mode is possible, the first SoC 30 is configured to instruct the BIST 38 to execute a self-inspection. The BIST 38 inspects the gyro sensor 36 in response to a self-inspection instruction from the first SoC 30.

The above has described in detail the inspection of three functions out of the multiple functions of the in-vehicle ECU 20. The in-vehicle ECU 20 can also execute the inspections on functions other than the three functions described above.

For example, the in-vehicle ECU 20 can read various adjustment values (e.g., the voltage value of the communication signal and the timing of reading data) for transmitting and receiving video signals between the serializer and the deserializer from the registers of the serializer and/or the deserializer in order to inspect the function of receiving video data from each camera 3, 4, and 5 and the function of displaying video using the display 11. In this case, if the read adjustment value is within the normal range, the in-vehicle ECU 20 can determine that the video data receiving function and the video display function are normal. On the other hand, if these adjustment values deviate from the normal range, depending on the degree of deviation, signs of a failure may be detected in the video data reception function or the video display function, and it may be determined that there is a possibility of failure.

Alternatively, the vehicle ECU 20 may transmit and receive inspection images at a higher speed (i.e., a higher communication load) than normal, such as the PCI communication function between the first SoC 30 and the second SoC 40, in order to inspect the video data reception function and the video display function. In this case, if the inspection image is transmitted and received normally, the in-vehicle ECU 20 can determine that the video data reception function and the video display function are normal. On the other hand, if the frequency of communication errors in transmission and reception of the inspection images is higher than a predetermined value, the in-vehicle ECU 20 may determine that a sign of the failure in the video data reception function or the video display function has detected and may be at risk of the failure.

Regarding the function of receiving reflection object data using the sonar 6, for example, the in-vehicle ECU 20 can control the sonar 6 to transmit an inspection pattern indicating the measurement results, and inspect the function of receiving the reflection object data based on whether or not the inspection pattern is received correctly. Furthermore, with regard to the warning sound generation function using the buzzer 7 and the audio output function using the audio circuit 12, for example, the in-vehicle ECU 20 can detect the impedance of each circuit when an inspection signal is output, and can inspect each function based on the change from the initial impedance. Furthermore, when inspecting the communication function using Bluetooth/WiFi, CAN communication, or ETHERNET communication, the in-vehicle ECU 20 can be inspected using the same method as in the case of the PCI communication.

Returning to the explanation of the flowchart in FIG. 3, the in-vehicle ECU 20 shifts to the inspection mode in step S130 and executes an inspection, and then proceeds to step S140. In step S140, the in-vehicle ECU 20 determines whether or not at least a sign of a failure has been detected during the inspection. If a sign of a failure is detected, the in-vehicle ECU 20 proceeds to step S150. On the other hand, if no sign of a failure is detected, the in-vehicle ECU 20 proceeds to step S160.

In step S150, the in-vehicle ECU 20 notifies the user of the vehicle 1 of at least the function for which the sign of the failure has been detected, for example, using the display 11 or the audio circuit 12. The process of step S150 corresponds to the notification unit of the present embodiments. In step S160, the in-vehicle ECU 20 causes a plurality of functions to execute normal operations in the normal operation mode.

In the flowchart of FIG. 3, the process of step S100 is executed periodically. Therefore, if, during the inspection mode of at least one function, the operation state of the vehicle 1 transitions to an operation state in which it is determined that the switch to the inspection mode of at least one function is not possible, the in-vehicle ECU 20 can terminate the inspection of at least one function and switch from the inspection mode to the normal operation mode.

### Second Embodiment

Next, an in-vehicle ECU 20 according to a second embodiment of the present embodiments will be described. The in-vehicle ECU 20 according to the embodiment is configured similarly to the in-vehicle ECU 20 according to the first embodiment. Therefore, a description of the configuration will be omitted.

In the first embodiment, an example is described in which the operation state of the in-vehicle ECU 20 mounted in the vehicle 1 is determined based on whether or not a user is disposed in the compartment of the vehicle, whether or not the vehicle is being charged, whether or not the driver is driving the vehicle 1, and the shift position in the transmission. However, in addition to or instead of determining the operation state of the in-vehicle ECU 20 in the first embodiment, the in-vehicle ECU 20 may execute the processing described below to determine the operation state of the in-vehicle ECU 20.

As shown in FIG. 10, the in-vehicle ECU 20 according to the embodiment can execute a plurality of applications (App1, App2, App3, App4, and the like). Each of the multiple applications is executed using at least one function among the multiple functions of the in-vehicle ECU 20. It should be noted that “I2C” in FIG. 10 is an abbreviation for Inter-Integrated Circuit, and corresponds to the communication function via each IF in the in-vehicle ECU 20.

Each of the plurality of applications turns on (i.e., “1”) a hardware flag corresponding to a function being used when it is executed, and turns off (i.e., “0”) the hardware flag corresponding to the function being used when it finishes executing. Here, for a function that is used by multiple applications, the corresponding hardware flag is turned off when the execution of all of the multiple applications is completed. The on or off state of these hardware flags indicates the operation state of the in-vehicle ECU 20 mounted on the vehicle 1 of the present embodiments.

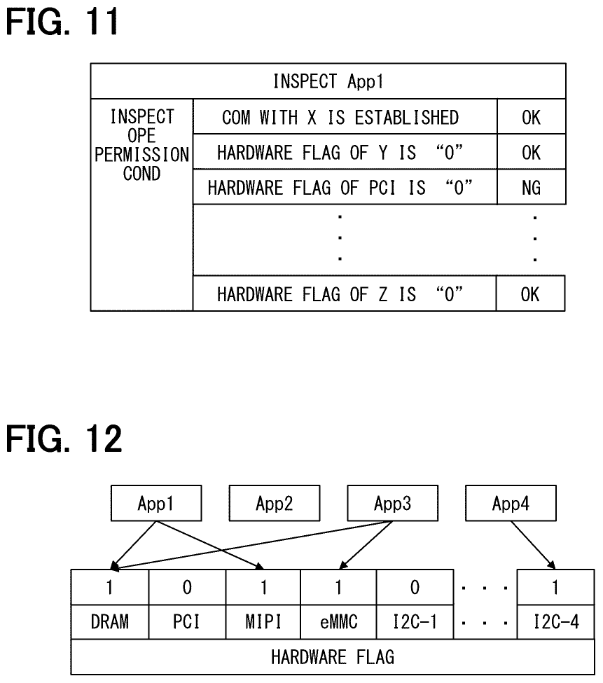

The in-vehicle ECU 20 defines, for each of a plurality of functions, a switch permission condition including a condition that the hardware flag is turned off, as shown in FIG. 11. The in-vehicle ECU 20 then determines that the function for which the switch permission condition is satisfied can be switched to the inspection mode, and determines that the function for which the switch permission condition is not satisfied cannot be switched to the inspection mode.

For example, in the example shown in FIG. 11, the condition that the PCI hardware flag is “0” is not satisfied, so the in-vehicle ECU 20 determines that the switch to the inspection mode is not permitted for the function for which the switch permission condition in FIG. 11 is defined.

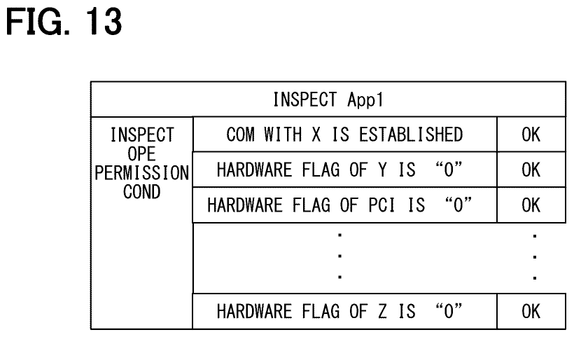

When App2, which is an application using the PCI communication function, finishes execution and the PCI hardware flag becomes “0” as shown in FIG. 12, the in-vehicle ECU 20 determines that the switch permission condition is satisfied as shown in FIG. 13, and determines that the switch to the inspection mode is permitted for the function for which the switch permission condition in FIG. 12 is defined.

As described above, by using hardware flags corresponding to a plurality of functions of the in-vehicle ECU 20, the operation state of the in-vehicle ECU 20 can be grasped in more detail.

### Modifications

One exemplary embodiment of the present disclosure is explained above. The present disclosure is not limited to the above-described embodiment, and can be implemented by various modifications without departing from the spirit of the present disclosure.

For example, in the first embodiment described above, if a failure or a sign of a failure is detected as a result of the inspection, the user is notified. Alternatively, the user may also be notified if no anomaly such as a failure or a sign of a failure is detected.

The device and the method described in the present disclosure may be implemented by a special purpose computer which includes a processor programmed to execute one or more functions executed by computer programs. The systems and methods described in this disclosure may be implemented using a dedicated hardware logic circuit. The device and the method described in the present disclosure may be also implemented by one or more dedicated computers which are constituted by combinations of a processor for executing computer programs and one or more hardware logic circuits. For example, some or all of the functions of the first SoC 30 and the second SoC 40 may be implemented as hardware. A configuration in which certain function is implemented by hardware logic circuitry includes a configuration in which the function is implemented using one or more ICs or the like. Some of the functions provided by the first SoC 30 and the second SoC 40 may be realized using IC (Integrated Circuit), or FPGA (Field-Programmable Gate Array). The aspect of the IC also includes ASIC (i.e., Application Specific Integrated Circuit). The computer program described above may be stored in a computer-readable non-transitory tangible storage medium as instructions to be executed by a computer. As a storage medium for storing the computer program, a hard disk drive (i.e., HDD), a solid state drive (i.e., SSD), a flash memory, or the like can be adopted. The scope of the present embodiments also includes programs for causing a computer to function as the first SoC 30 and the second SoC 40, and forms of non-transitory tangible storage media such as semiconductor memory on which these programs are stored.

### Embodiments of Technical Features

This description discloses a plurality of technical features described in a plurality of sections listed below. A feature may be described in multiple dependent form, referencing to more than one preceding features in an alternative form. Further, a feature may be written in multiple-multiple dependent form, referencing to multiple features that include a feature that is in the multiple dependent form. These features described in a multiple dependent form define multiple technical features. Furthermore, the technical concepts described in the following paragraphs also apply to the inspection method executed by the in-vehicle electronic control device.

### Technical feature 1

An in-vehicle electronic control device (20) executes an inspection of each of a plurality of functions that the in-vehicle electronic control device has in a state where the in-vehicle electronic control device is mounted on a vehicle. The in-vehicle electronic control device includes: an acquisition unit (S100) that acquires information about an operation state of the in-vehicle electronic control unit; a determination unit (S110, S120) that determines whether or not each of the plurality of functions are able to be switched from a normal operation mode in which an normal operation is executed to an inspection mode in which the inspection is executed, based on the operation state acquired by the acquisition unit; and an inspection unit (S130) that switches to the inspection mode and executes the inspection for one of the plurality of functions that have been determined by the determination unit to be able to be switched to the inspection mode.

### Technical Feature 2

In the in-vehicle electronic control device according to technical feature 1, the determination unit grasps the operation state of the in-vehicle electronic control device from at least whether a user is disposed in a compartment of the vehicle and a shift position of the vehicle, and determines whether to switch to the inspection mode in which the inspection is executed for each of the plurality of functions based on a grasped operation state.

### Technical Feature 3

In the in-vehicle electronic control device according to technical feature 1 or 2, the in-vehicle electronic control device can execute a plurality of applications. Each of the plurality of applications is executed using at least one of the plurality of functions among the plurality of functions of the in-vehicle electronic control device. Each of the plurality of applications turns on a flag corresponding to one of the plurality of functions that is being used when the application is executed, and turns off the flag corresponding to the one of the plurality of functions that was being used when the application is finished executing. The determination unit defines, for each of the plurality of functions, a switch permission condition including the flag being turned off as the operation state of the in-vehicle electronic control device. The determination unit determines that one of the plurality of functions, for which the switch permission condition is satisfied, can be switched to the inspection mode. The determination unit determines that one of the plurality of functions, for which the switch permission condition is not satisfied, can not be switched to the inspection mode.

### Technical Feature 4

In the in-vehicle electronic control device according to any one of technical features 1 to 3, during the inspection of at least one of the plurality of functions being executed, when the operation state of the in-vehicle electronic control device transitions to an operation state in which the determination unit determines that the at least one of the plurality of functions can not be switched to the inspection mode, the inspection unit terminates the inspection of the at least one of the plurality of functions and switches from the inspection mode to the normal operation mode.

### Technical Feature 5

The in-vehicle electronic control device according to any one of technical features 1 to 4 further includes a notification unit (S150) that notifies a user of a result of the inspection executed by the inspection unit.

### Technical Feature 6

In the in-vehicle electronic control device according to technical feature 5, the notification unit notifies the user when an anomaly is detected in the inspection executed by the inspection unit.

### Technical Feature 7

In the in-vehicle electronic control device according to any one of technical features 1 to 6, the inspection unit includes an inspection circuit (37, 51) for inspecting a functional circuit (23, 25) that realizes at least one function among the plurality of functions of the in-vehicle electronic control device, and a switching circuit (50) for switching a connection destination of the functional circuit to the inspection circuit. The inspection unit uses the switching circuit to switch the connection destination of the functional circuit to the inspection circuit in response to the determination unit determining that the switch to the inspection mode is possible.

### Technical Feature 8

The in-vehicle electronic control device according to any one of technical features 1 to 6, further includes a functional circuit (36) that realizes at least one of the plurality of functions among the plurality of functions of the in-vehicle electronic control device. The functional circuit includes an inspection circuit (38) for inspecting the functional circuit. The inspection unit instructs the inspection circuit to execute the inspection in response to the determination unit determining that the switch to the inspection mode is possible.

### Technical Feature 9

The in-vehicle electronic control device according to any one of technical features 1 to 8, the inspection unit executes the inspection by operating at least one of the plurality of functions at a load higher than a normal load when the at least one of the plurality of function is operating normally in the inspection mode for the at least one of the plurality of functions.

Reference numeral 1 indicates a vehicle, reference numeral 2 indicates a power supply, reference numeral 3 indicates a periphery monitoring camera, reference numeral 4 indicates a side camera, reference numeral 5 indicates a DSM camera, reference numeral 6 indicates a sonar, reference numeral 7 indicates a buzzer, reference numeral 8 indicates an antenna, reference numeral 11 indicates a display, reference numeral 12 indicates an audio circuit, reference numeral 21 indicates a power supply circuit, reference numeral 30 indicates a first SoC, reference numerals 31 to 33 indicate video ICs, reference numerals 34 to 35 indicate IFs, reference numeral 36 indicates a gyro sensor, reference numeral 40 indicates a second SoC, reference numeral 41 indicates a wireless IC, reference numerals 42 to 43 indicate IFs, reference numeral 44 indicates a video IC, and reference numeral 45 indicates an IF.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An in-vehicle electronic control device for executing an inspection of each of a plurality of functions that the in-vehicle electronic control device has in a state where the in-vehicle electronic control device is mounted on a vehicle, the in-vehicle electronic control device comprising:
at least one of (i) a circuit and (ii) a processor with a memory storing computer program code executable by the processor, wherein:
the at least one of the circuit and the processor is configured to cause the in-vehicle electronic control device to execute:
acquiring information about an operation state of the in-vehicle electronic control device;
determining whether or not each of the plurality of functions are able to be switched from a normal operation mode in which an normal operation is executed to an inspection mode in which the inspection is executed, based on the operation state acquired in the acquiring of the information; and
switching to the inspection mode and executing the inspection for one of the plurality of functions that has been determined to be able to be switched to the inspection mode.

2. The in-vehicle electronic control device according to claim 1, wherein:
the at least one of the circuit and the processor is configured to cause the in-vehicle electronic control device to execute: acquiring information about the operation state of the in-vehicle electronic control device as an acquisition unit;
the at least one of the circuit and the processor is configured to cause the in-vehicle electronic control device to execute: determining whether or not each of the plurality of functions are able to be switched from the normal operation mode in which the normal operation is executed to the inspection mode in which the inspection is executed, based on the operation state acquired in the acquiring of the information as a determination unit; and
the at least one of the circuit and the processor is configured to cause the in-vehicle electronic control device to execute: switching to the inspection mode and executing the inspection for the one of the plurality of functions that has been determined to be able to be switched to the inspection mode as an inspection unit.

3. The in-vehicle electronic control device according to claim 2, wherein:
the determination unit grasps the operation state of the in-vehicle electronic control device from at least whether a user is disposed in a compartment of the vehicle and which is a shift position of the vehicle, and determines whether to switch to the inspection mode in which the inspection is executed for each of the plurality of functions based on a grasped operation state.

4. The in-vehicle electronic control device according to claim 2, wherein:
the in-vehicle electronic control device can execute a plurality of applications;
each of the plurality of applications is executed using at least one of the plurality of functions among the plurality of functions of the in-vehicle electronic control device;
each of the plurality of applications turns on a flag corresponding to one of the plurality of functions that is being used when each of the plurality of applications is executed, and turns off the flag corresponding to the one of the plurality of functions that was being used when each of the plurality of applications is finished executing;
the determination unit defines, for each of the plurality of functions, a switch permission condition including the flag being turned off as the operation state of the in-vehicle electronic control device;
the determination unit determines that one of the plurality of functions, for which the switch permission condition is satisfied, can be switched to the inspection mode; and
the determination unit determines that one of the plurality of functions, for which the switch permission condition is not satisfied, can not be switched to the inspection mode.

5. The in-vehicle electronic control device according to claim 2, wherein:
during the inspection of at least one of the plurality of functions being executed, when the operation state of the in-vehicle electronic control device transitions to another operation state in which the determination unit determines that the at least one of the plurality of functions cannot be switched to the inspection mode, the inspection unit terminates the inspection of the at least one of the plurality of functions and switches from the inspection mode to the normal operation mode.

6. The in-vehicle electronic control device according to claim 2, wherein:
the at least one of the circuit and the processor is configured to cause the in-vehicle electronic control device to further execute: notifying a user of a result of the inspection executed by the inspection unit.

7. The in-vehicle electronic control device according to claim 6, wherein:
the at least one of the circuit and the processor is configured to cause the in-vehicle electronic control device to further execute: notifying the user of the result of the inspection executed by the inspection unit as a notification unit.

8. The in-vehicle electronic control device according to claim 7, wherein:
the notification unit notifies the user when an anomaly is detected in the inspection executed by the inspection unit.

9. The in-vehicle electronic control device according to claim 2, wherein:
the inspection unit includes an inspection circuit for inspecting a functional circuit that realizes at least one function among the plurality of functions of the in-vehicle electronic control device, and a switching circuit for switching a connection destination of the functional circuit to the inspection circuit; and
the inspection unit uses the switching circuit to switch the connection destination of the functional circuit to the inspection circuit in response to the determination unit determining that switching to the inspection mode is possible.

10. The in-vehicle electronic control device according to claim 2, further comprising:
a functional circuit that realizes at least one of the plurality of functions among the plurality of functions of the in-vehicle electronic control device, wherein:
the functional circuit includes an inspection circuit for inspecting the functional circuit; and
the inspection unit instructs the inspection circuit to execute the inspection in response to the determination unit determining that switching to the inspection mode is possible.

11. The in-vehicle electronic control device according to claim 2, wherein:
the inspection unit executes the inspection by operating at least one of the plurality of functions at a load higher than a normal load when the at least one of the plurality of function is operating normally in the inspection mode for the at least one of the plurality of functions.

12. The in-vehicle electronic control device according to claim 1, wherein:
the plurality of functions includes a power supply function, a video data reception function, a reflection object data reception function, a warning sound generation function, a rotational acceleration data detection function, a communication function, a video display function, and an audio output function; and
the plurality of functions are utilized for a control of the vehicle.

13. An inspection method for inspecting a plurality of functions of an in-vehicle electronic control device using the in-vehicle electronic control device when the in-vehicle electronic control device is mounted on a vehicle, the inspection method comprising:
acquiring information about an operation state of the in-vehicle electronic control device;
determining whether or not each of the plurality of functions are able to be switched from a normal operation mode in which an normal operation is executed to an inspection mode in which an inspection is executed, based on acquired operation state; and
switching to the inspection mode and executing the inspection for one of the plurality of functions that has been determined that is able to be switched to the inspection mode.

14. The inspection method according to claim 13, wherein:
the plurality of functions includes a power supply function, a video data reception function, a reflection object data reception function, a warning sound generation function, a rotational acceleration data detection function, a communication function, a video display function, and an audio output function; and
the plurality of functions are utilized for a control of the vehicle.

15. A non-transitory computer readable storage medium comprising instructions being executed by a computer, the instructions including a computer-implemented method for inspecting a plurality of functions of an in-vehicle electronic control device using the in-vehicle electronic control device when the in-vehicle electronic control device is mounted on a vehicle, the instructions including:
acquiring information about an operation state of the in-vehicle electronic control device;
determining whether or not each of the plurality of functions are able to be switched from a normal operation mode in which an normal operation is executed to an inspection mode in which an inspection is executed, based on acquired operation state; and
switching to the inspection mode and executing the inspection for one of the plurality of functions that has been determined that is able to be switched to the inspection mode.

16. The non-transitory computer readable storage medium according to claim 15, wherein:
the plurality of functions includes a power supply function, a video data reception function, a reflection object data reception function, a warning sound generation function, a rotational acceleration data detection function, a communication function, a video display function, and an audio output function; and
the plurality of functions are utilized for a control of the vehicle.
